(19) United States
(12) Patent Application Publication
(10) Pub. No.: US 2022/0205643 A1
(43) Pub. Date: Jun. 30, 2022

(54) SYSTEM FOR INDICATING STATUS OF A FOOD ITEM IN A KITCHEN

(71) Applicant: Technology Licensing Corporation, Fort Lauderdale, FL (US)

(72) Inventors: Bernard G. Koether, Fort Lauderdale, FL (US); Edward J. Musial, Monroe, CT (US); Michael Keefe, Brookfield, CT (US)

(21) Appl. No.: 17/563,758

(22) Filed: Dec. 28, 2021

Related U.S. Application Data
(60) Provisional application No. 63/131,596, filed on Dec. 29, 2020.

(51) Int. Cl. F24C 15/16; A47J 36/32; F24C 15/04

(52) U.S. Cl. CPC F24C 15/16; F24C 15/04; A47J 36/32

(57) ABSTRACT

A system for indicating status of a food item in a kitchen includes a food preparation appliance having at least one shelf. A countdown timer operatively communicates with the food preparation appliance for counting a food processing time period of a food item in the at least one shelf. A processor receives a count from the countdown timer. A visual indicator provides a visual indication at the at least one shelf. The processor communicates with the visual indicator and causes the visual indicator to indicate a current status of a food item in the at least one shelf as a function of the count from the countdown timer.

### CROSS REFERENCE TO RELATED APPLICATION

This application claims the benefit of U.S. Provisional Application No. 63/131,596 filed on Dec. 29, 2020, the entire disclosure of which is hereby incorporated in its entirety.

### BACKGROUND OF THE INVENTION

The present invention is directed to a system and method for operating a food handling appliance which indicates the food status; the stage of a recipe process being performed on a food at, or within a portion of, the food handling appliance.

As is known in the art in modern commercial kitchens, food is prepared utilizing sophisticated cooking appliances in accordance with user known, or pre-programmed recipes. In connection with recipes, the food is cooked for a predetermined period of time at a predetermined temperature and is then done. In some instances the same appliance may cook the same item at various temperatures during the performance of the recipe, and may even hold the food item to be cooled or heated during a holding period.

Once done, the food is either removed from the appliance to be served, or transferred to a holding station. In some instances the appliance itself may serve as the holding station. There is no opportunity for the operator in the kitchen environment to literally stand over the cooking appliance, such as a fryer, oven, grill or the like to determine the status of the food within the cooking appliance as the status changes.

Restaurants, cafeterias, quick serve restaurants and the like also make use of holding stations, to free up the cooking appliances to meet demand. Holding stations are most usually heated appliances near the point of sale or service area to maintain the food in a heated edible condition. However, food safety guidelines put maximum limits on the amount of time for which food may be held at the holding station. After the end of the holding period the food cannot be used for restaurant consumption.

Currently food preparers must empirically monitor cooking appliance and/or holding station to determine the current status of any food. Holding times and cooking times require continuous monitoring by the food preparers. However, as a result of preparers multitasking with functions other than monitoring a specific appliance or holding area, food may be prepared improperly with respect to the recipe or a holding area may run out of food product before the holding time elapses, or the holding time may elapse before an order is made to prepare more food.

While it is known in the art to provide end of cycle alarms to indicate to the operators when a holding period has ended, or a food preparation cycle has ended, these have proved inadequate because from a distance it is difficult to determine for which section of the appliance or holding area the alarm pertains. Furthermore, alarms may be missed as a result of distracted operators, and one cannot determine the current status of the food from the appliance prior to an end of cycle alarm. In other words, one looking at a shelf in an oven cannot determine whether the food is cooking or being held as a warming station without some other knowledge with respect to the entire cooking operation.

Accordingly, a system which overcomes the shortcomings of the prior art is desired.

### SUMMARY OF THE INVENTION

A system for indicating status of a food item in a kitchen includes a food preparation appliance. The food preparation appliance has at least one food preparation section. A count down timer is operatively coupled to the food preparation appliance for counting a food processing period associated with each of the at least one food preparation sections. A processor receives a count from the countdown timer. A visual indicator provides a visual indication at the at least one food preparation section indicating a status of an item of food within the at least one food preparation section. The processor communicates with the visual indicator and causes the visual indicator to indicate a current status of a food item in the at least one food preparation section as a function of the count from the countdown timer.

### DETAILED DESCRIPTION OF THE DRAWINGS

The present disclosure is better understood by reading the written description with reference to the accompanying drawings and figures in which the reference numerals denote similar structure and refer to the elements throughout in which:

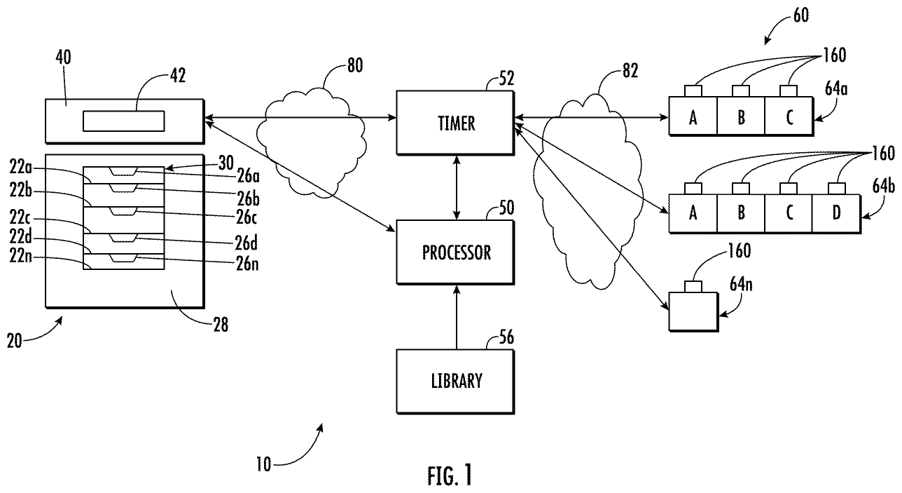

FIG. 1 is a schematic diagram of a system for indicating status of a food item in a kitchen;

FIG. 2 is a cooking appliance as known in the art; and

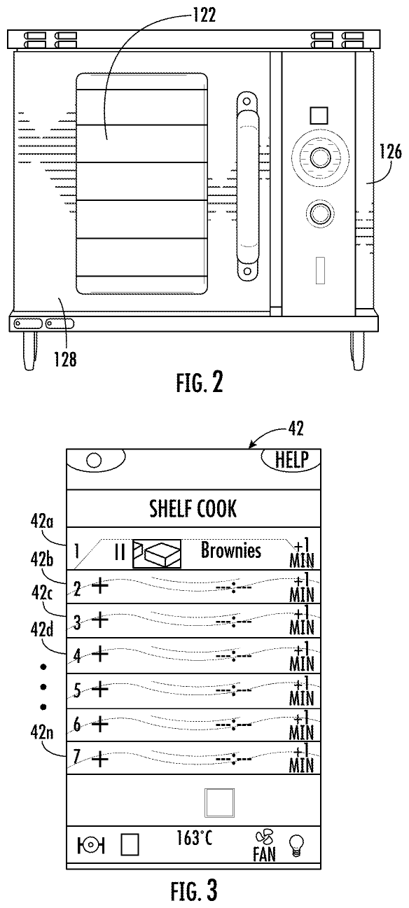

FIG. 3 is a graphical user interface operating in accordance with the invention.

### DETAILED DESCRIPTION OF THE PREFERRED EMBODIMENTS

The present description is made with reference to the accompanying drawings, in which various embodiments are shown. However many different embodiments may be used and thus the description should not be construed as limited to the embodiments set forth herein. Rather, these embodiments are provided so that the disclosure will be thorough and complete. Like numbers refer to like elements throughout.

Reference is first made to FIG. 1 in which a schematic diagram of a system 10 for indicating food status constructed in accordance with the invention is provided. System 10 includes a food preparation appliance, such as an oven 20, with an appliance controller 40 for operating oven 20 in response to inputs from a graphical user interface (“GUI”) 42. A processor 50 communicates with appliance controller 40. A countdown timer 52 is in communication with processor 50 and may also communicate with cooking appliance 20. In a preferred nonlimiting embodiment a holding station 60 also communicates with processor 50 and/or timer 52.\

Oven 20 includes a plurality of shelves 22a-22n. As known in the art each of shelves 22a-22n may be thermally isolated from each other and have their own respective heating element (not shown) for heating the space between successive shelves 22a and 22b by way of example forming a plurality of distinct food preparation sections. In one embodiment of the invention, oven 20 includes a door 28 having a window 30 therein. A respective visual indicator 26a-26n is disposed within a respective food preparation section associated with each shelf 22a-22n and is visible through window 30.

The controller 40 is operatively coupled with oven 20 and controls each respective heating element associated with a respective shelf 22a-22n in accordance with recipes. Controller 40 includes a user interface such as GUI 42 for user input of instructions for operating oven 20 and for displaying information thereon.

Controller 40 also enables inputs at GUI 42 providing intake of instruction as a result of touching the appropriate portion of GUI 42. By way of nonlimiting example, as shown in FIG. 3, and as will be discussed in greater detail below, GUI 42 may be divided into sections 42a-42n; each corresponding to a different shelf 22a-22n. Touching the image of a shelf in a respective section 42a-42n of GUI 42 causes operation of a recipe assigned to that shelf by processor 50 to begin.

In response to being touched, GUI 42 sends a signal to controller 40 to begin that recipe causing controller 42 begin a cook process for an indicated item at the indicated shelf 22 and operate in accordance with instructions from processor 50.

In a preferred nonlimiting embodiment processor 50 communicates with controller 40 across a cloud 80. Processor 50 determines a recipe (the time and temperature for cooking) associated with each shelf 22 of oven 20 and provides the recipe to controller 40 to operate oven 20 in accordance with the recipe assigned to a respective shelf 22. In one embodiment, controller 40 may store a recipe for each respective shelf 22a-22n and communicating with processor 50 only when it is determined that a recipe for a particular shelf requires changing. In a more preferred embodiment, processor 50 communicates with a library 56 of recipes and selects the appropriate recipe for real-time communication with controller 40 in response to a food type and shelf input at GUI 42.

Count down timer 52 is in communication with both controller 40 and processor 50. Recipes are a function of time, therefore when controller 40 begins a cooking process in a respective shelf, controller 40 sends a start signal to timer 52 which begins a countdown of that stage of a recipe; a first stage may be preheat shelf 22; a second stage may be hold shelf 22 at a predetermined temperature for 30 minutes for cooking; and a third stage may be a holding stage of holding a shelf 22 at a lower temperature to maintain food warm, without overcooking, for no more than a mandated time period. A countdown completion signal is sent to processor 50. In response to the countdown completion signal processor 50 provides operating instruction to controller 50 for controlling the operation of oven 20 on a shelf by shelf basis.

Each shelf 22a-22n of oven 20 is provided with a respective visual indicator 26a-26n for indicating a condition within a respective shelf 22 corresponding to a stage experienced within shelf 22 of a food lifecycle. In a preferred nonlimiting embodiment, visual indicators 26 may be a single LED, or a series of LED/lights capable of indicating at least 3 distinct colors. By way of example, continuing the example above, if cooking brownies, a yellow light indication may be an indicator of the pre heating stage for a respective shelf 22. A green light indication may be an indicator of a cooking stage. An orange light may be an indicator of completion of the cooking cycle and an intermediate blue light may indicate a holding stage after completion of a cooking stage. A red light may indicate the end of the entire lifecycle and need for destruction of the food. It is also well within the scope of the invention that one indication, for a cooking stage (food status) by way of example, may be no color at all; the null set.

An operator selects a recipe for a shelf by providing a food type as an input to a respective section 42a-42n of GUI 42. This becomes the input signal for controller 40 which communicates the food type to processor 50. In response to the input signal controller 40 begins operation of the selected shelf 22 in accordance with the recipe steps retrieved from library 56 by processor 50, and sends a start signal to timer 52 to begin a countdown for the first stage of the cooking operation. The signal is also sent to processor 50 which provides a visual control signal for indicating which color of a visual indicator should be shown. Controller 40 operates the visual indicator 26 corresponding to the shelf 22 under control in response to the visual control signal.

The current food type being operated upon is known to processor 50 and/or controller 40. In a preferred embodiment, the selected food type remains stored at controller 40 or processor 50 to keep communications with library 56 at a minimum. If the food type input at GUI 42 is a new food type to be cooked within a shelf 22 of cooking appliance 20, then processor 50 will retrieve the recipe corresponding to the indicated food type for the instructions upon which controller 40 operates. Again, as discussed above, timer 52 and controller 40 operate in accordance with the selected recipe.

When timer 52 completes its countdown, it provides an end of count signal to processor 50. Processor 50 provides a signal to controller 40 to change the color of the visual indicator 26 to indicate the completion of one phase of the food lifecycle, and resulting food status, and the entering of the next. Controller 40 then sends a second time start signal to timer 52 to begin the countdown of the time period corresponding to this next stage and the process repeats until the food is sold or destroyed. It is also understood that the new count can begin in response to the change color signal being sent by processor 50 to timer 52 at the same time as controller 40.

In one embodiment, controller 40, processor 50 and timer 52 may be a single unit at oven 20. However, in a preferred nonlimiting embodiment, processor 50 and timer 52 are distinct structures, remote from controller 40, to enable a single processor 50 and timer 52 to operate as discussed above with respect to a number of cooking appliances. It should also be noted that that the cooking appliance is an oven 20 for this embodiment. However system 10 is also applicable to other food preparation appliances such as a fryer having multiple baskets, a proofing station having a number of distinct shelves for proofing, drawer warmers, dump stations or the like.

Additionally GUI 42 may be remote from controller 40. In a preferred nonlimiting embodiment a GUI 42 may communicate with two or more controllers 40 for two or more associated cooking appliances 20. As result, a single GUI 42 located at a back-office may control the cooking appliances 20 located at a number of different locations either within the same restaurant or even in restaurants at physically distinct locations.

As a result of system 10, by providing a visual indicator, which changes with the life stage currently experienced by a food product within a food preparation appliance, a user can easily determine the status of any food product within the kitchen. By clearly associating the indicator with the section of the food preparation apparatus corresponding to the food being monitored, the cast work associated with audio alarms is eliminated. For cooking appliances without windows, GUI 42 may be utilized to indicate a status of food held within the appliance. By way of example line 42a of GUI 42 may indicate red for completion of food contained in a first shelf of the cooking appliance, or green for cooking; in a manner similar to the visual indicators within the shelves discussed above.

Prior art ovens 122, such as the one shown in FIG. 2, have shelves 122 and doors 128. However they do not have visual indicators associated with each shelf. In a second embodiment of the invention, an embodiment of the invention compatible with such prior art ovens 120 is provided. An aftermarket GUI for controller 40, or the GUI control 42 already associated with such prior art appliances, may be utilized in accordance with the invention. GUI 42 itself becomes the visual indicator for indicating the status currently being experienced by the food in an associated section of the food preparation appliance 120.

As seen from FIG. 2, each section 42a-42n of GUI 42 is associated with a respective shelf 122 of oven 120. Each section 42a-42n of GUI 42 indicates a food (image of the food may be shown) contained at the shelf 122 and a color such as green indicative of the status of the food as it cooks. It is sections 42a-42n of GUI 42, corresponding to respective positions within the cooking appliance which become a visual indicator 26. Again, the operator of oven 120 can tell the food item and the status of that food item at a glance. Section 42a in this example may change from green to red to indicate a status that the food lifecycle is over.

In yet another embodiment, section 42a of GUI 42, by way of example, may actually show the current condition of the food utilizing a changing food image rather than a color indication. In this embodiment, timer 52 provides a continuous countdown clock to processor 50; timer 52 continuously provides the countdown; not the end of the count to processor 50. Processor 50 calculates a change in color of the food item over time given the temperature parameters of the recipe being operated by controller 40. Processor 50 determines, utilizing either an algorithm for calculating a change in color of the food, or a lookup table of library images stored in library 56 as a function of elapsed time, and transmits a control signal to controller 40 for changing the image at GUI 42 for the food being cooked.

By way of nonlimiting example, a roast beef cooked on shelf 22a of oven 20 is monitored at section 42a of GUI 42. The initial image would be of a pink or red roast; over time the image may change to gray to brown to black indicating a stage of cooking from raw to rare to well done for the meat.

When utilizing cooking appliances, particularly the same appliance to cook a variety of foods, the operators must be careful to prevent cross contamination of one food by another cooked in the same appliance. By way of example, in a bread baking oven having a plurality of shelves, baking cheesy garlic bread gives off odors during baking which would ruin a loaf of white bread which is prized for its pureness in flavor. Therefore, bakers do not cook breads giving off different strong odors with other breads in the same cooking appliance. Similarly, a fryer may be utilized to fry chicken having a spicy recipe. Frying the spicy chicken can change the flavor of the oil; making it inappropriate for batches of plain chicken or french fries thereafter. Lastly, in cooking appliances which do not have appropriate insulation, a shelf about to perform a cooking step may be inappropriate in a warming oven as it may raise the temperature of the overall cooking appliance to a degree in which food is overcooked. The system 10 can be utilized to warn operators of these potential food preparation hazards.

In one embodiment of the invention, library 56 stores a table of contraindications for foods and food cooking appliances. By way of example, cheesy garlic bread and white bread should not be cooked in the same cooking appliance; for certain appliances, warming and cooking should not be carried out simultaneously; or plain food should not be prepared in a fryer once spicy food has been prepared in the fryer. This is accomplished by the fact that as discussed above, at least one of controller 40 and processor 50 stores the food type and recipe currently being processed, or last processed. Upon an operator entering an operation at GUI 42, processor 50 compares the selected food type and corresponding recipe for contraindications stored in library 56 with a previous recipe. If the comparison determines that the newly selected recipe is inappropriate, processor 50 causes GUI 42 or lights 26 to provide a warning such as a red warning, a flashing light indication or the like to indicate to the operator not to perform the selected recipe until remedial action is taken.

It is also well known in the art that during different stages of the cooking operation food may be transferred from appliance to appliance. For example bread may be initially processed in a proofer, transferred to a baking oven, and then to a holding station prior to sale. Next, system 10 will be described in connection with operation for a second food staging area; namely holding station 60.

Holding station 60 includes a plurality of substations 64a-64n which are communicatively coupled to processor 50 and timer 52 through cloud 82. Each holding station 64 is provided with a respective address known to processor 50. Furthermore, as known in the art each individual holding station 64a-64n may include one or more holding channels A-D to allow for holding a variety of foods under different conditions. By way of example, holding station 64a may be a plurality of steam trays while holding station 64b may be a plurality of different channeled A-D heat lamps at a variety of temperatures whereas holding station 64n may be chilled.

Each channel A-D of each holding station 64a-64n has a respective visual indicator 160 similar in construct to the visual indicators 26 and 42a-42n discussed above; capable of utilizing color indication or photo indication to indicate the status of food within the respective holding station channel associated with that visual indicator 160. The only difference is that at a holding station the status indicated by a visual indicator 160 are fresh, and expired, or due to expire within a predetermined time period; an indication to make more.

During operation either oven 20 or holding station 60 sends a start signal to timer 52 that food has been transferred from oven 20 to holding station 60. As discussed above, timer 52 then begins a countdown corresponding to a spoilage time period and outputs that countdown to processor 50. Processor 50 output an addressable signal to the respective one of holding station 64a-64n to which the food has been transferred, to at first cause visual indicators 160 to indicate food is available. Processor 50 monitoring the countdown of timer 52 determines when a predetermined time of interest prior to food expiring occurs and causes a change of indication for that visual indicator 160 to change indication to indicate food about to expire. At the end of the countdown of timer 52 processor 50 outputs a signal to the respective indicator 160 corresponding to timed out to change the indication to a color such as red to indicate that the hold period has expired.

Thus while there have been shown, described and pointed out novel features of the present invention as applied to preferred embodiments thereof, it will be understood that various omissions and substitutions and changes in the form and detail are contemplated so that the disclosed invention may be made by those skilled in the art without departing from the spirit and scope of the invention. It is the intention therefore, to be limited only as indicated by the scope of the claims appended hereto. It is also to be understood that the following claims are intended to cover all of the generic and specific features of the invention herein described and all statements of the scope of the invention, which, as a matter of language might be said to fall therebetween.

What is claimed is:

1. A system for indicating status of a food item in a kitchen comprising:
a food preparation appliance, the food preparation appliance having at least one food preparation section;
a countdown timer operatively communicating with the food preparation appliance for counting a food processing time period of a food item in the at least one food preparation section;
a processor receiving a count from the countdown timer; and
a visual indicator providing a visual indication at the at least one food preparation section, the processor communicating with the visual indicator and causing the visual indicator to indicate a current status of a food item in the at least one food preparation section as a function of the count from the countdown timer.

2. The system of claim 1, wherein the food preparation appliance has at least a second food preparation section, each food preparation section being a shelf.

3. The system of claim 2, wherein a the visual indicator includes at least two visual indicators, each respective visual indicator being associated with a respective shelf to indicate a condition of the shelf with which the visual indicator is associated.

4. The system of claim 2, wherein each shelf is thermally isolated from an adjacent shelf.

5. The system of claim 3, further comprising a door for selectively sealing the food preparation appliance, a window disposed within the door, the visual indicator being visible through the window.

6. The system of claim 1, wherein the food preparation appliance has at least a second food preparation section, each food preparation section being a shelf, each shelf being thermally isolated from an adjacent shelf, the visual indicator being disposed on a respective shelf, for indicating a condition of a food item disposed in the shelf, and a door for selectively sealing the food preparation appliance, a window disposed within the door, each visual indicator being visible through the window.

7. The system of claim 1, further comprising a controller communication with the processor for operating each food preparation section in accordance with a respective recipe.

8. The system of claim 7, further comprising a library communicating with the controller, the library storing two or more recipes, the controller causing the processor to operate the food preparation section in accordance with a first recipe at a first food preparation section and a second recipe at a second preparation section, the recipe including the count.

9. The system of claim 1 wherein the visual indicator changes from a first condition to a second condition at an end of the count.

10. The system of claim 1, comprising a second food preparation device, the controller operatively communicating with the food preparation device and the second food preparation device, the controller performing a second count when a food item is transferred from the food preparation device to the second food preparation device.

11. The system of claim 10, wherein the second count is a continuation of the first count.

12. The system of claim 10, wherein the second food preparation device is a holding station.

13. The system of claim 2, wherein the food preparation appliance comprises an input for inputting a food type to be processed; the processor receiving the input of the food type to be processed and determining whether there is a contraindication for preparing the input food type in the food preparation appliance at the food preparation section; and
the visual indicator providing a visual indication at the at least one food preparation section, the processor communicating with the visual indicator and causing the visual indicator to indicate a warning if a contraindication exists as determined by the processor.

14. A system for indicating status of a food item in a kitchen comprising:
a food preparation appliance, the food preparation appliance having at least one food preparation section;
an input for inputting a food type to be processed;
a processor receiving the input of the food type to be processed and determining whether there is a contraindication for preparing the input food type in the food preparation appliance; and
a visual indicator providing a visual indication at the at least one food preparation section, the processor communicating with the visual indicator and causing the visual indicator to indicate a warning if a contraindication exists as determined by the processor.

15. The system of claim 14, wherein the food preparation appliance has at least a second food preparation section, each food preparation section being a shelf.

16. The system of claim 15, wherein each shelf is thermally isolated from an adjacent shelf.

17. The system of claim 14, further comprising a controller communication with the processor for operating each food preparation section in accordance with a respective recipe.

18. The system of claim 17, further comprising a library communicating with the controller, the library storing two or more recipes, the controller causing the processor to operate the food preparation section in accordance with a first recipe at a first food preparation section and a second recipe at a second preparation section, the controller determining the contraindication as a function of the two or more recipes.
